(19) United States
(12) Patent Application Publication
(10) Pub. No.: US 2009/0161517 A1
(43) Pub. Date: Jun. 25, 2009

(54) Optical imaging device and optical sensor thereof

(75) Inventors: Chih-Ming Lin, Taichung City (TW); Hung-Lu Chang, Taichung City (TW); Ping-Jung Wu, Yuanlin Township (TW); Tzuan-Ren Jeng, Hsinchu City (TW)

Correspondence Address: RABIN & Berdo, PC, 1101 14TH STREET, NW, SUITE 500, WASHINGTON, DC, 20005, US

(73) Assignee: INDUSTRIAL TECHNOLOGY RESEARCH INSTITUTE, Hsinchu (TW)

(21) Appl. No.: 12/071,818

(22) Filed: Feb. 27, 2008

(30) Foreign Application Priority Data
Dec. 19, 2007 (TW) 096148774

(51) Int. Cl. G11B 7/00

(52) U.S. Cl. 369/103

(57) ABSTRACT

An optical imaging device and an optical sensor thereof are described. The optical sensor is used for sensing a signal light. The optical sensor includes a plurality of photosensitive pixels and at least one absorption wall. The absorption wall is disposed between the photosensitive pixels, and a top of the absorption wall is higher than photosensitive surfaces of the photosensitive pixels. Herein, the photosensitive pixels are used for receiving an incident signal light, and the absorption wall is used for absorbing non-parallel light components in the signal light.

### CROSS-REFERENCE TO RELATED APPLICATIONS

This non-provisional application claims priority under 35 U.S.C. §119(a) on Patent Application No(s). 096148774 filed in Taiwan, R.O.C. on Dec. 19, 2007, the entire contents of which are hereby incorporated by reference.

### BACKGROUND OF THE INVENTION

1. Field of Invention

The present invention relates to an optical imaging device and an optical sensor thereof, which are applied in an optical system such as, but not limited to, a holographic storage optical system.

2. Related Art

In the current optical storage medium market, among various ultra-capacity recording techniques being widely developed, holographic recording and reproduction technique having a high recording density and fast data transmission rate is the most potential one. In a holographic recording and reproduction optical system, a planar wave transmitted parallel to a system optic axis is converted into a signal light carrying the signal of the data to be recorded via a spatial light modulator (SLM) serving as a data input device.

Then, the signal light is converged to a recording medium by a Fourier lens. Another coherent reference light intersects the signal light on the recording medium, such that the recording medium may change a refraction index distribution correspondingly due to the interference of the two lights. In other words, due to the interference between the reference light and signal night, the data to be recorded is recorded on the recording medium in the form of interference pattern.

During the data signal reconstruction, the reference light is incident on the interference pattern at a specific position of the recording medium, so as to produce a diffracted light or also referred to as a reproduced light. The diffracted light or reproduced light is imaged on the optical sensor serving as a data output device, such as a charge coupled device (CCD), via the Fourier lens. Then, by using an image compensation and coding/decoding technology, the corresponding data signal is restored and reproduced.

However, when passing through interference pattern on the elements on the optical path such as an aperture stop or a recording medium, the light is optically diffracted, and thus the reproduced light passing through the Fourier lens contains light components which are not parallel to the system optic axis. Moreover, the light components intersect on the photosensitive pixels of the optical sensor, so as to cause the so-called cross-talk or noise, thereby further affecting the quality of the restored and reproduced data signal.

Moreover, the stronger the optical diffraction is, the more the light components being not parallel to the system optic axis become, and thus the stronger the cross-talk or noise is. For example, in a holographic recording and reproduction system, the light spot of the signal light projected on the recording medium is controlled by the aperture stop, so as to control the recording density. Therefore, in order to increase the recording density, the size of the aperture of the aperture stop is reduced. However, when the aperture of the aperture stop is reduced, the stronger optical diffraction may occur accordingly, such that the cross-talk or noise becomes stronger. In other words, in the optical system, the scattered light such as the above non-parallel light components is the source of the noise of the reproduced light.

### SUMMARY OF THE INVENTION

In view of the above problems, the present invention is directed to an optical imaging device and an optical sensor thereof for solving the problems in the prior art.

The optical sensor disclosed in the present invention is used for sensing a signal light. The optical sensor includes a plurality of photosensitive pixels and at least one absorption wall.

The absorption wall is disposed between the photosensitive pixels, and a top of the absorption wall is higher than photosensitive surfaces of photosensitive pixels.

Herein, the photosensitive pixels are used for receiving the incident signal light, and the absorption wall is used for absorbing non-parallel light components in the signal light.

The absorption wall surrounds the photosensitive pixels. Herein, the absorption wall is an absorption layer having through holes, and the photosensitive pixels are disposed on bottoms of the through holes. Alternatively, each absorption wall is disposed correspondingly to one photosensitive pixel. For example, the absorption wall is a hollow column structure, and the photosensitive pixel-is located on the bottom of the hollow inside the corresponding absorption wall.

Furthermore, the absorption wall has an internal surface adjoining the top surface and adjacent to the photosensitive pixels. The internal surface of the absorption wall is parallel to parallel light components in the signal light, or inclined to the photosensitive pixels.

The optical imaging device disclosed in the present invention includes a lens member, a stop, an optical sensor, and an optical path converter.

The lens member, the stop, the optical path converter, and the optical sensor are sequentially arranged on an optic axis. In other words, the stop is located on the optic axis of the lens member, and the optical path converter is disposed on the other side of the stop opposite to the lens member.

The optical sensor includes a plurality of photosensitive pixels and at least one absorption wall. The absorption wall is disposed between the photosensitive pixels, and the top of the absorption wall is higher than the photosensitive surfaces of the photosensitive pixels.

The lens member converges a light on the stop, such that the converged light is diffracted to form a diffracted light. The optical path converter parallelizes the diffracted light (e.g., collimates the diffracted light) and guides the parallelized diffracted light to the optical sensor for being received by the photosensitive pixels in the optical sensor. Moreover, the non-parallel light components in the diffracted light are absorbed by the absorption wall.

The optical imaging device disclosed in the present invention is used for reproducing data for a recording medium. The optical imaging device includes a light source module, an optical sensor, and an optical path converter.

The optical sensor includes a plurality of photosensitive pixels and at least one absorption wall. The absorption wall is disposed between the photosensitive pixels, and the top of the absorption wall is higher than the photosensitive surfaces of the photosensitive pixels. The optical path converter is located between the recording medium and the optical sensor.

The light source module is used for generating a reference light. When the reference light is incident on the recording medium, the reference light is diffracted by the recording medium to generate a holographic signal light. The optical path converter guides the holographic signal light to the light detector for being received by the photosensitive pixels in the optical sensor. Moreover, the non-parallel light components in the holographic signal light are absorbed by the absorption wall.

Based on the above, by using the optical sensor of the present invention, the signal interference caused by the diffraction of the optic path elements, such as cross-talk or noise, can be alleviated. In other words, the non-parallel light components in the signal light are avoided from being incident on the adjacent photosensitive pixels to cause interference.

### BRIEF DESCRIPTION OF THE DRAWINGS

The present invention will become more fully understood from the detailed description given herein below for illustration only, and thus are not limitative of the present invention, and wherein:

FIG. 1 is a general cross-sectional view of an optical sensor according to an embodiment of the present invention;

FIG. 2A is a general top view of a partial structure of the optical sensor according a first embodiment of the present invention;

FIG. 2B is a general top view of a partial structure of the optical sensor according a second embodiment of the present invention;

FIG. 2C is a general top view of a partial structure of the optical sensor according a third embodiment of the present invention;

FIG. 2D is a general top view of a partial structure of the optical sensor according a fourth embodiment of the present invention;

FIG. 2E is a general top view of a partial structure of the optical sensor according a fifth embodiment of the present invention;

FIG. 2F is a general top view of a partial structure of the optical sensor according a sixth embodiment of the present invention;

FIG. 2G is a general top view of a partial structure of the optical sensor according a seventh embodiment of the present invention;

FIG. 3 is a schematic cross-sectional view of an optical imaging device according to the first embodiment of the present invention;

FIG. 4 is a schematic cross-sectional view of an optical imaging device according to the second embodiment of the present invention; and

FIG. 5 is a schematic relationship diagram between the optical sensor and the sensed signal according to an embodiment of the present invention.

### DETAILED DESCRIPTION OF THE INVENTION

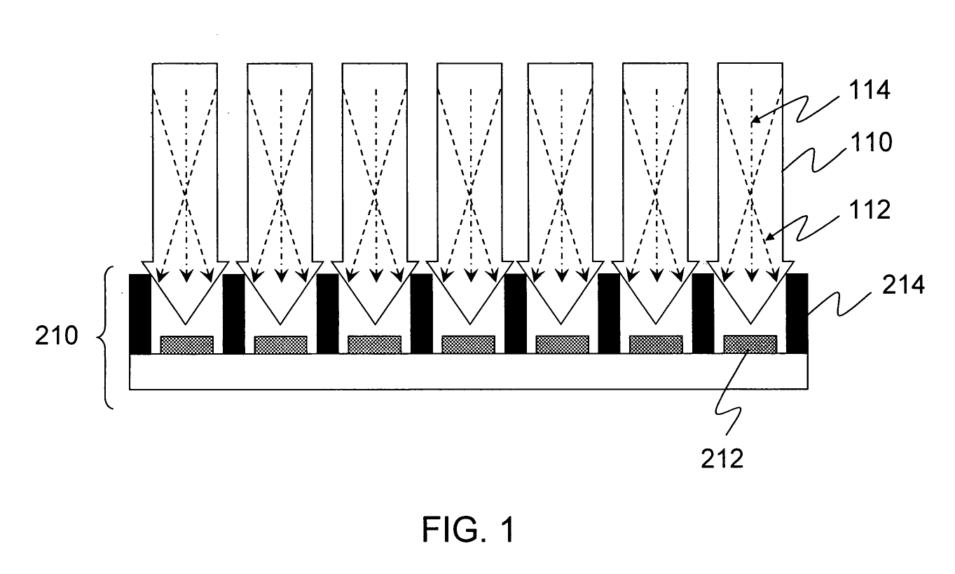

Referring to FIG. 1, an optical sensor according to an embodiment of the present invention is shown. The optical sensor 210 is used for sensing a signal light 110. The optical sensor 210 includes a plurality of photosensitive pixels 212 and one or more absorption wall 214. The absorption wall 214 is disposed between the photosensitive pixels 212, extends towards the upstream of the signal light 110, and has a top surface higher than photosensitive surfaces of the photosensitive pixels 212. In other words, the absorption wall 214 extends towards the source of the signal light 110 relatively to the photosensitive surfaces of the photosensitive pixels 212, such that the absorption wall 214 has a specific height, and the top surface of the absorption wall 214 adjacent to the source of the signal light 110 is higher than the photosensitive surfaces of the photosensitive pixels 212. That is, the top surface of the absorption wall 214 is closer to an upstream element (not shown) before the optical sensor 210 on the same optical path than the photosensitive surfaces of the photosensitive pixels 212.

Herein, the signal light 110 is appropriately vertically incident on the photosensitive surfaces of the photosensitive pixels 212, and the optical sensor 210 receives the incident signal light 110 and generates a data signal corresponding to the received signal light 110.

In other words, the signal light 110 has non-parallel light components 112 and parallel light components 114. The parallel light components 114 in the signal light 110 is vertically incident on the photosensitive surfaces of the photosensitive pixels 212 for detecting. The non-parallel light components 112 in the signal light 110 is incident on the absorption wall 214, and absorbed by the absorption wall 214. That is to say, the absorption wall 214 prevents the interference caused by the non-parallel light components 112 in the corresponding signal light 110 incident on the adjacent photosensitive pixels 212.

The absorption wall 214 has an internal surface adjoining the top surface and adjacent to the photosensitive pixels 212. The internal surface of the absorption wall 214 is parallel to the parallel light components 114 in the signal light 110 or inclined to the photosensitive pixels 212.

Herein, the higher the absorption wall 214 is, the closer the top of the absorption wall 214 is to an upstream element (not shown) before the optical sensor 210 on the same optical path, and the more non-parallel light components 112 the absorption wall 214 absorbs.

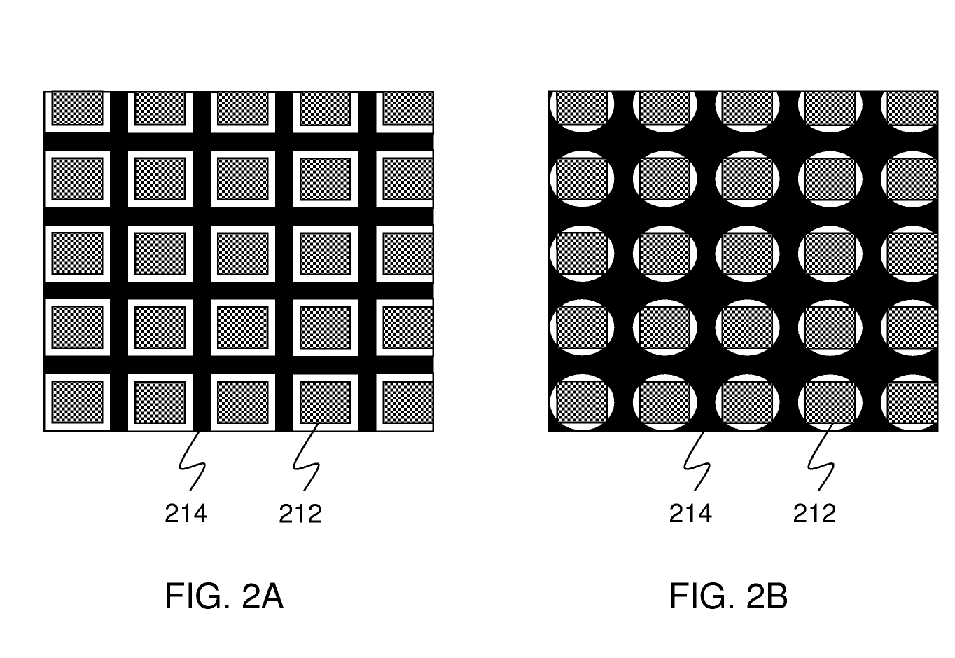

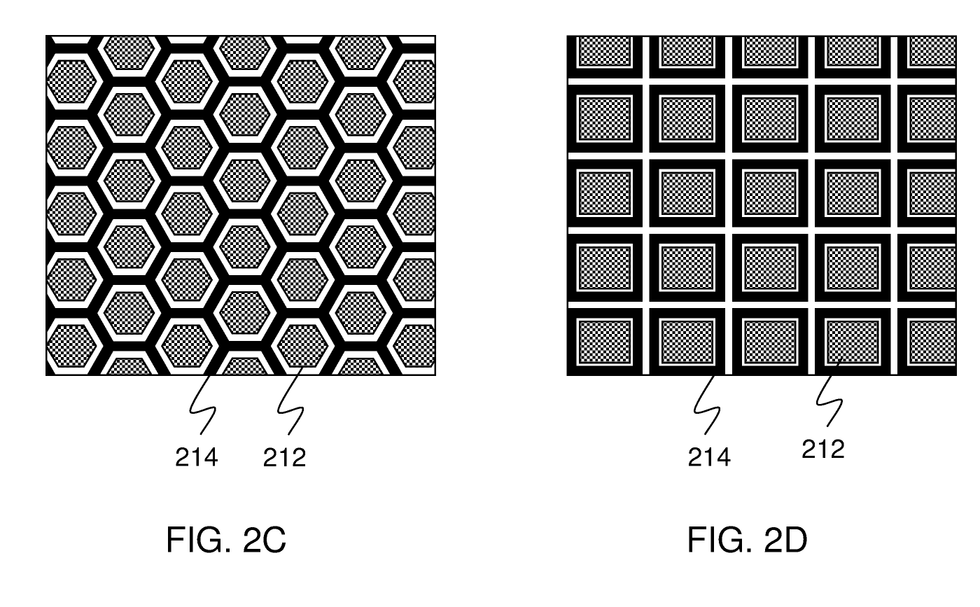

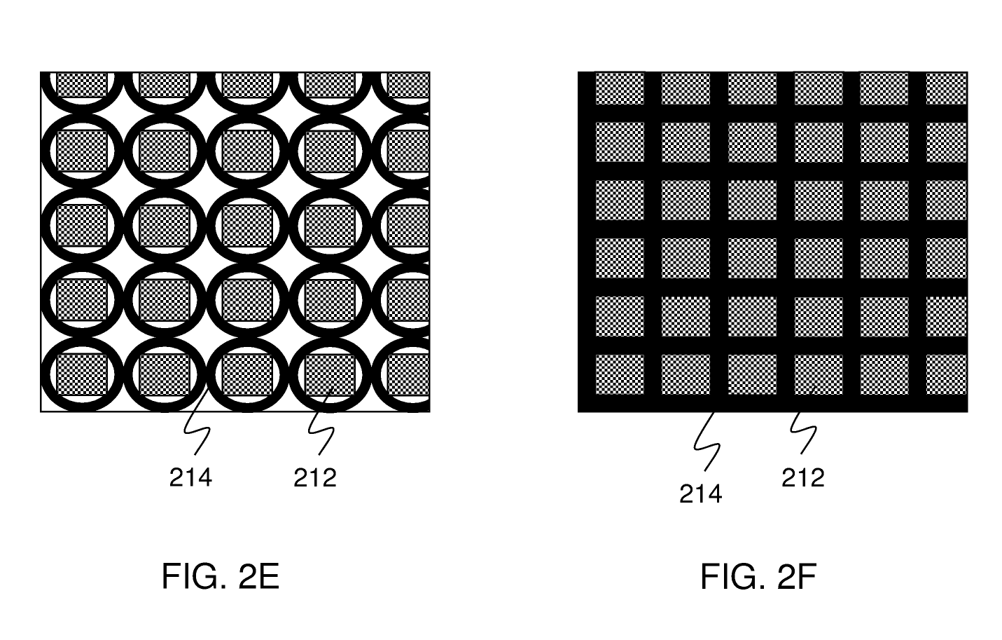

The absorption wall 214 surrounds each photosensitive pixel 212, as shown in FIG. 2A.

For example, the absorption wall 214 may be an absorption layer having through holes, and the photosensitive pixel 212 is disposed on the bottom of each through hole. Furthermore, the through hole may be any geometric figure surrounding the photosensitive pixels 212, such as circle, oval, triangle, rectangle, hexagon, and polygon, as shown in FIGS. 2A, 2B, and 2C.

Furthermore, the absorption wall 214 is disposed correspondingly to each photosensitive pixel 212. Herein, the absorption wall 214 may be a hollow column structure, and the photosensitive pixel 212 is located on the bottom inside the absorption wall 214, as shown in FIGS. 2D and 2E. Moreover, the shape of the hollow column structure may be any geometric figure such as circle, oval, triangle, rectangle, hexagon, and polygon. Moreover, the internal shape (the shape of the hollow) and the external shape (the shape of the whole column) of the hollow column structure may be identical, similar, or different.

In other words, the shape enclosed by the internal surface (i.e., the side surface adjoining the top surface) of the absorption wall 214 is fitted with (i.e., identical or similar to) the shape of the photosensitive surface of the photosensitive pixel 212, or different from the photosensitive surface of the photosensitive pixel 212.

Moreover, the absorption wall 214 is separated from the photosensitive pixel 212, as shown in FIGS. 2A-2E, or disposed at the edge of the photosensitive pixel 212, as shown in FIGS. 2F and 2G.

Moreover, the absorption wall 214 may surround the photosensitive pixel 212 or not. In other words, each absorption wall 214 is corresponding to one of the photosensitive pixels 212, that is, each photosensitive pixel 212 may be corresponding to at least one absorption wall 214. Also, the photosensitive pixel 212 is located beside the side surface of the corresponding absorption wall 214 adjoining the top surface.

Herein, the absorption wall 214 may be a structure directly made of a light absorbing material protruding from the periphery of the photosensitive pixel 212. Herein, the light absorbing material used for forming the structure of the absorption wall may be, but not limited to, any organic and inorganic material for absorbing most of the visible lights or lights of specific wavelengths, such as, but not limited to, color photoresist, dye, and ink. The absorption wall may be, but not limited to, a structure of any color for absorbing specific wavelengths or a black structure for absorbing most of the visible lights.

Furthermore, the absorption wall 214 may be a structure made of any material protruding from the periphery of the photosensitive pixel 212, but the surface of the protruding structure or the internal surface is coated with a light absorbing material. Herein, the light absorbing material may be used to be formed on the surface of the structure, and the light absorbing material coated on the surface may be, but not limited to, any organic and inorganic material for absorbing most of the visible lights or lights of specific wavelengths. The absorption wall has, but is not limited to, a surface of any color for absorbing specific wavelengths or a black surface for absorbing most of the visible lights.

In the process, a photosensitive pixel array is firstly formed on a semiconductor substrate, and then the absorption wall is formed on the periphery of the photosensitive pixel. Herein, the absorption wall may be formed by directly adhering the formed absorption wall to the periphery of the photosensitive pixel, or coating a light absorbing material of a specific thickness on the periphery of the photosensitive pixel. The absorption wall may also be formed by using any material to form the structure of the absorption wall firstly, and then coating a light absorbing material on the surface of the structure.

Alternatively, a photosensitive pixel array is firstly formed on a semiconductor substrate, then a layer of specific material (such as, but not limited to, spin-coating a photoresist of a specific color) is coated thereon, and a through hole array is developed or etched at the positions for forming the photosensitive pixels, so as to expose the photosensitive pixel array. Herein, the specific material layer may be a light absorbing material or any other material coated with a light absorbing material after the through holes are formed.

The optical sensor according to the present invention may be applied in various optical imaging devices, such as video camera and holographic recording and reproduction system. Also, by using the optical sensor according to the present invention, the signal interference such as cross-talk or noise caused by the diffraction of the optical path element is further alleviated.

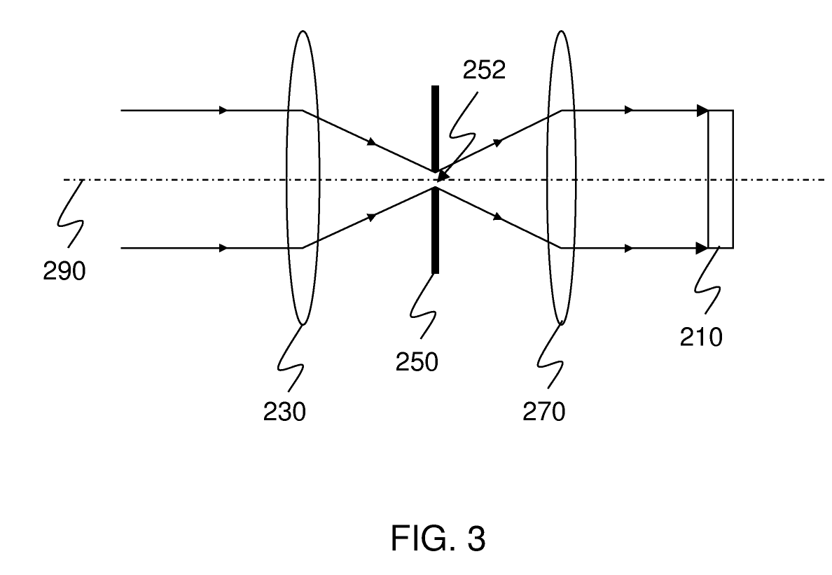

Referring to FIG. 3, an optical imaging device according to a first embodiment of the present invention is shown. The optical imaging device includes an optical sensor 210, a lens member 230, a stop 250, and an optical path converter 270.

In the optical imaging device, a system optic axis 290 is set on the optical path of each element. The system optic axis 290 is also an optic axis of each element in the optical imaging device. The signal light proceeds from an emitting end (such as, a light source) to a receiving end (such as, an optical sensor) along the optic axis. The path (i.e., a forwarding direction (not shown)) of the optic axis may be changed by optical reflecting elements such as a light reflector or a light splitter.

The lens member 230, the stop 250, the optical path converter 270, and the optical sensor 210 are disposed on the system optic axis 290 sequentially.

A light source (not shown) is provided on the other side of the lens member 230 opposite to the stop 250 for supplying light.

The stop 250 is located on the optic axis of the lens member 230. The lens member 230 converges the light from the light source to an aperture 252 of the stop 250, such that the light converged by the lens member 230 is diffracted to form a diffracted light. In other words, the light passing through the aperture 252 of the stop 250 is optically diffracted.

The optical path converter 270 is disposed on the other side of the stop 250 opposite to the lens member 230. Herein, the optical path converter 270 converts the divergent light into a parallel light, and guide the direction of the light. That is to say, the optical path converter 270 parallelizes the diffracted light from the stop 250, and then guides the parallelized diffracted light to the optical sensor 210.

That is to say, the optical path converter 270 is constituted by a single or multiple lenses including, for example, condensing lens, collimating lens, object lens.

Referring to FIG. 1 at the same time, the optical sensor 210 includes a plurality of photosensitive pixels 212 and one or more absorption wall 214. The absorption wall 214 is disposed between the photosensitive pixels 212, and the absorption wall 214 extends towards the upstream of the diffracted light (corresponding to the signal light 110 in FIG. 1), and the top surface of the absorption wall 214 is higher than the photosensitive surface of the photosensitive pixel 212.

The parallelized diffracted light is guided by the optical path converter 270 to be incident on the optical sensor 210, and received by the photosensitive pixels 212. The incident diffracted light has parallel light components being parallel to the system optic axis 290 and non-parallel light components being not parallel to the system optic axis 290. Herein, the non-parallel light components are incident on the absorption wall 214, and absorbed by the absorption wall 214.

Herein, the absorption wall 214 has an internal surface adjoining the top surface and adjacent to the photosensitive pixel 212. The internal surface of the absorption wall 214 is parallel to the parallel light components in the diffracted light incident on the optical sensor 210, i.e., parallel to the system optic axis, or inclined to the photosensitive pixel 212.

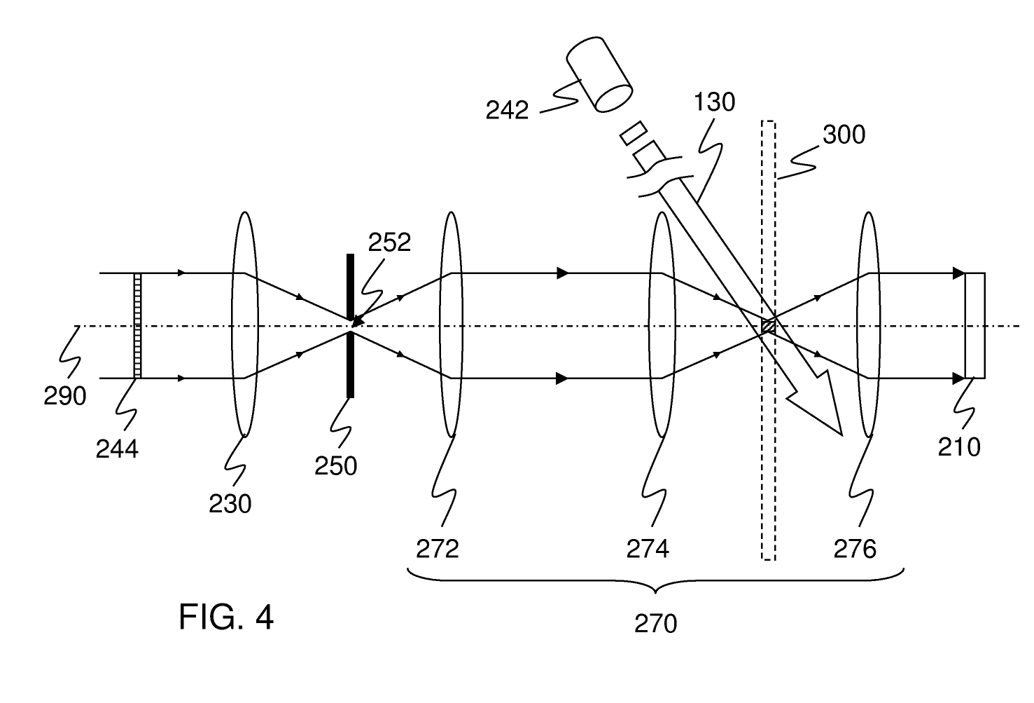

Moreover, the optical imaging device may be a holographic recording and reproduction system, for reproducing data for a holographic recording medium 300, as shown in FIG. 4. The holographic recording and reproduction system includes an optical sensor 210, a light source module, a lens member 230, a stop 250, and an optical path converter 270.

In the optical imaging device, a system optic axis 290 is set on the optical path of each element. The system optic axis 290 is also an optic axis of each element in the optical imaging device. The signal light proceeds from an emitting end (such as, the light source) to a receiving end (such as, the optical sensor) along the optic axis. The path (i.e., a forwarding direction (not shown)) of the optic axis may be changed by the optical reflecting elements such as a light reflector or a light splitter.

The light source module, the lens member 230, the stop 250, the optical path converter 270, and the optical sensor 210 are arranged on the system optic axis 290 sequentially.

Herein, the stop 250 is located on the optic axis of the lens member 230. The optical path converter 270 is disposed on the other side of the stop 250 opposite to the lens member 230.

The optical path converter 270 is constituted by a single or multiple lenses including, for example, condensing lens, collimating lens, object lens.

In this embodiment, the optical path converter 270 includes lens members 272, 274, and 276, and the lens members 272, 274, and 276 are aligned and arranged from the upstream to the downstream of the light signal.

The holographic recording medium 300 is disposed in the optical path converter 270. In this embodiment, the holographic recording medium 300 is disposed between the lens members 274 and 276.

The light source 242 in the light source module produces coherent lights. The light source 242 is split into two beams via a splitter set (not shown) in the light source module. One beam is modulated into a signal light via a spatial light modulator 244 in the light source module, and the other beam serves as a reference light 130.

During recording, the signal light is converged by the aperture 252 of the stop 250 via the lens member 230, so as to be optically diffracted, such that the signal light passing through the stop 250 has optical components being not parallel to the system optic axis 290. The stop 250 is a spatial filtering element for filtering the scattered light except the signal light. After passing through the stop 250, the signal light is incident on the lens member 272, and is parallelized by the lens member 272, that is, the signal light is collimated by the lens member 272. The collimated signal light is converged on the recording medium 300 via the lens member 274 (i.e., object lens).

At this time, the signal light intersects the reference light 130 on the recording medium 300, such that the recording material of the recording medium 300 has a chemical reaction due to the interference of the two beams, so as to change the distribution of the refraction index correspondingly, that is, the signal is recorded on the recording medium in the form of interference pattern.

During the signal reconstruction, the reference light 130 is incident on a specific position of the recording medium 300, that is incident on the interference pattern of the recording material, so as to be diffracted to generate a holographic signal light. Then, the optical path converter 270 guides the holographic signal light to the optical sensor 210.

Referring to FIG. 1 together, the optical sensor 210 is used for sensing a signal light 110. The optical sensor 210 includes a plurality of photosensitive pixels 212 and one or more absorption wall 214. The absorption wall 214 is disposed between the photosensitive pixels 212, the absorption wall 214 extends towards the upstream of the holographic signal light (corresponding to the signal light 110 in FIG. 1), and the top surface of the absorption wall 214 is higher than the photosensitive surfaces of the photosensitive pixels 212.

In other words, the holographic signal light is collimated and guided to the optical sensor 210 by the lens member 276 in the optical path converter 270, and then received by the photosensitive pixels 212 in the optical sensor 210. The holographic signal light (corresponding to the signal light 110 in FIG. 1) has parallel light components being parallel to the system optic axis 290 and non-parallel light components being not parallel to the system optic axis 290. Herein, the non-parallel light components are incident on the absorption wall 214, and absorbed by the absorption wall 214.

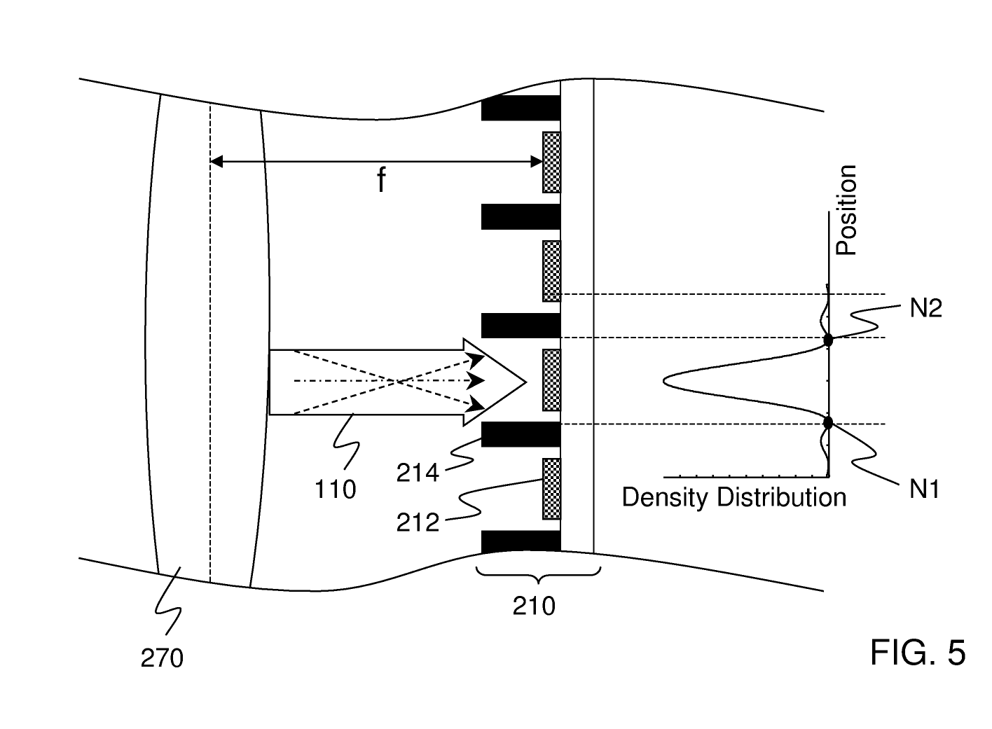

Referring to FIG. 5, the optical sensor 210 is spaced from the adjacent upstream element by a distance of a focal length. In this embodiment, the upstream element is an optical path converter 270, for example, the lens member 276 in the optical path converter 270 in FIG. 4. The signal light 110 passing through the optical path converter 270 is incident on the optical sensor 210. The relationship between the corresponding intensity distribution and position of the signal light 110 is shown as a curve diagram at the right side of FIG. 5. The positions N1 and N2 are null positions, which are obtained by dividing a wavelength (λ) of the signal light 110 by a stop aperture width (A), that is λ/A. The signal light 110 has non-parallel light components.

In the optical sensor having no absorption wall, the non-parallel light components may be incident on the adjacent photosensitive pixels, so as to cause the interference between the corresponding signals out of the range from position N1 to position N2 and the corresponding signals in the range from position N1 to position N2 adjacent to the photosensitive pixels.

In the optical sensor according to the present invention, the non-parallel light components are absorbed/blocked by the absorption wall 214 in the optical sensor 210, so as to prevent the non-parallel light components from being incident on the adjacent photosensitive pixels 212, and further alleviate the signal interference such as cross-talk or noise produced by the diffraction of the optical path elements.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An optical sensor for sensing a signal light, the optical sensor comprising:
a plurality of photosensitive pixels, for receiving the signal light which is incident thereto; and
at least one absorption wall, disposed between the photosensitive pixels, for absorbing non-parallel light components in the signal light, wherein a top of the absorption wall is higher than photosensitive surfaces of the photosensitive pixels.

2. The optical sensor as claimed in claim 1, wherein the absorption wall surrounds the photosensitive pixels.

3. The optical sensor as claimed in claim 1, wherein each the absorption wall is corresponding to one of the photosensitive pixels, and each of the photosensitive pixels is located beside a side surface of the corresponding absorption wall adjoining the top.

4. The optical sensor as claimed in claim 1, wherein the absorption wall has at least one side surface adjoining the top, and the side surface is adjacent to the photosensitive pixels and parallel to parallel light components in the signal light.

5. The optical sensor as claimed in claim 1, wherein the absorption wall has at least one side surface adjoining the top, and the side surface is adjacent to the photosensitive pixels and inclined to the photosensitive pixels.

6. An optical imaging device, comprising:
a lens member, for converging a light;
a stop, located on an optic axis of the lens member, the stop for causing the light converged by the lens member to be diffracted into a diffracted light;
an optical sensor, comprising:
a plurality of photosensitive pixels, for receiving the diffracted light; and
at least one absorption wall, disposed between the photosensitive pixels, the absorption wall for absorbing non-parallel light components in the diffracted light, wherein a top of the absorption wall is higher than photosensitive surfaces of the photosensitive pixels; and
an optical path converter, disposed on a side of the stop opposite to the lens member, the optical path converter for parallelizing the diffracted light and guiding the parallelized diffracted light to the optical sensor.

7. The optical imaging device as claimed in claim 6, wherein the absorption wall surrounds the photosensitive pixels.

8. The optical imaging device as claimed in claim 6, wherein each the absorption wall is corresponding to one of the photosensitive pixels, and each of the photosensitive pixels is located inside the corresponding absorption wall.

9. The optical imaging device as claimed in claim 6, wherein the absorption wall has at least one side surface adjoining the top, and the side surface is adjacent to the photosensitive pixels and parallel to parallel light components in the diffracted light.

10. The optical imaging device as claimed in claim 6, wherein the absorption wall has at least one side surface adjoining the top, and the side surface is adjacent to the photosensitive pixels and inclined to the photosensitive pixels.

11. An optical imaging device, for reproducing data for a recording medium, comprising:
a light source module, for generating a reference light, wherein when the reference light is incident to the recording medium, the reference light is diffracted into a holographic signal light by the recording medium.
an optical sensor, comprising:
a plurality of photosensitive pixels, for receiving the holographic signal light; and
at least one absorption wall, disposed between the photosensitive pixels, the absorption wall for absorbing non-parallel light components in the holographic signal light, wherein a top of the absorption wall is higher than photosensitive surfaces of the photosensitive pixels; and
an optical path converter, located between the recording medium and the optical sensor, for guiding the holographic signal light to the optical sensor.

12. The optical imaging device as claimed in claim 11, wherein the absorption wall surrounds the photosensitive pixels.

13. The optical imaging device as claimed in claim 11, wherein each absorption wall is corresponding to one of the photosensitive pixels, and the photosensitive pixels are located inside the corresponding absorption wall.

14. The optical imaging device as claimed in claim 11, wherein the absorption wall has at least one side surface adjoining the top, and the side surface is adjacent to the photosensitive pixels and parallel to the parallel light components in the holographic signal light.

15. The optical imaging device as claimed in claim 11, the absorption wall has at least one side surface adjoining the top, and the side surface is adjacent to the photosensitive pixels and inclined to the photosensitive pixels.
